(19) United States
(12) Patent Application Publication
(10) Pub. No.: US 2002/0126127 A1
(43) Pub. Date: Sep. 12, 2002

(54) Lighting processing circuitry for graphics adapter

(75) Inventor: Thomas Winters Fox, Georgetown, TX (US)

Correspondence Address: Joseph P. Lally, DEWAN & LALLY, L.L.P, P.O. BOX 684749, Austin, TX, 78768-4749, US

(73) Assignee: International Business Machines Corporation, Armonk, NY (US)

(21) Appl. No.: 09/758,787

(22) Filed: Jan. 11, 2001

(51) Int. Cl. G06T 15/50

(52) U.S. Cl. 345/581; 345/426

(57) ABSTRACT

A lighting circuit for use in a graphics adapter of a data processing system is disclosed. The circuit includes a geometry stage configured to receive the coordinates of a graphic primitive vertex and the vertex's normal vector. The circuit may calculate a first set of values equal to the dot product of the normal vector and a unit vector from the vertex to a corresponding light source, a second set of values equal to the dot product of the normal vector and a unit half vector, and a third set of values equal to the product of an attenuation factor associated with each light source and a spotlight factor associated with each light source. The lighting circuit further includes a color stage for receiving the first, second, and third sets of values from the geometry stage and further configured to calculate a primary vertex color based thereon.

### BACKGROUND

1. Field of the Present Invention

The present invention relates generally to computer graphics and more particularly to a lighting processor circuit that efficiently determines primary and secondary colors.

2. History of Related Art

Graphics display subsystems are almost universally employed in microprocessor based computer systems to facilitate a variety of graphics tasks and applications including computer-assisted drafting, architectural design, simulation trainers for aircraft and other vehicles, molecular modeling, virtual reality applications, and video games. Graphics processors, graphics adapters, and a variety of similarly designed computer products provide specialized hardware to speed the execution of graphics instructions and rendering of graphic images. These processors and adapters typically include, for example, circuitry optimized for translating, rotating, and scaling 3D graphic images.

In a typical application, a graphical image that is displayed on a display terminal or other output device is composed of one or more graphic primitives. For purposes of this disclosure, a graphic primitive may be thought of as one or more points, lines, or polygons that are associated with one another, such as by being connected to one another. Typically, the displayed image is generated by creating one or more graphic primitives, assigning various attributes to the graphic primitives, defining a viewing point and a viewing volume, determining which of the graphic primitives are within the defined viewing volume, and rendering those graphic primitives as they would appear from the viewing point. This process can require a tremendous amount of computing power to keep pace with the ever increasingly complex graphics applications that are commercially available. Accordingly, designers of graphics systems and graphics applications are continuously seeking cost-effective means for improving the efficiency at which graphic images are rendered and displayed.

Typically a software application program generates a 3D graphics scene, and provides the scene, along with lighting attributes, to an application programming interface (API) such as the OpenGL® API developed by Silicon Graphics, Inc. Complete documentation of OpenGL® is available in M. Woo et al., OpenGL Programming Guide: The Official Guide to Learning OpenGL, Version 1.2 (Addison Wesley Longman, Inc. 1999) and D. Schreiner, OpenGL Reference Manual, Third Edition: The Official Reference Document to OpenGL, Version 1.2 (Addison Wesley Longman, Inc. 1999), both of which are incorporated by reference herein.

A 3D graphics scene typically includes of a number of polygons that are delimited by sets of vertices. The vertices are combined to form larger primitives, such as triangles or other polygons. The triangles (or polygons) are combined to form surfaces, and the surfaces are combined to form objects. Each vertex is associated with a set of attributes. Vertex attributes may include a position, including three Cartesian coordinates x, y, and z, a material color, which describes the color of the object to which the vertex belongs, and a normal vector, which describes the direction to which the surface is facing at the vertex. Each vertex may also be associated with texture coordinates and/or an alpha (transparency) value. In addition, the scene itself may be associated with a set of attributes including, as examples, an ambient color that typically describes the amount of ambient light and one or more individual light sources. Each light source has a number of properties associated with it, including a direction, an ambient color, a diffuse color, and a specular color.

Rendering is employed within the graphics system to create two-dimensional image projections of a 3D graphics scene for display on a monitor or other display device. Typically, rendering includes processing geometric primitives (e.g., points, lines, and polygons) by performing one or more of the following operations as needed: transformation, clipping, culling, lighting, fog calculation, and texture coordinate generation. Rendering further includes processing the primitives to determine component pixel values for the display device, a process often referred to specifically as rasterization.

The OpenGL® API specification and other API's such as the graPHIGS API define lighting equations used to determine color values for each vertex. These equations include require fairly extensive use of floating point calculations including floating point addition, multiplication, exponentiation, inversion, and so forth. If calculated with software, each of these floating point calculations can require an undesirably large number of processor cycles. A floating point exponentiation calculation, for example, is notoriously slow (i.e., expensive) in a graphics adapter that relies on software to perform the calculation. It is therefore desirable to implement a hardware circuit that can calculate lighting parameter values to generate color values in a graphics engine efficiently.

### BRIEF DESCRIPTION OF THE DRAWINGS

Objects and advantages of the invention will become apparent upon reading the following detailed description and upon reference to the accompanying drawings in which:

FIG. 1 is a block diagram of a data processing system according to one embodiment of the present invention;

FIG. 2 is a block diagram of an embodiment of the graphics adapter of FIG. 1;

FIG. 3 is a block diagram of an embodiment of a geometry pipeline of the graphics adapter of FIG. 2;

FIG. 4 is a block diagram of the lighting stage of FIG. 3 according to one embodiment of the invention;

FIG. 5 is a block diagram of a lighting geometry processor of FIG. 4;

FIG. 6 is a block diagram of an embodiment of the color lighting processor of FIG. 4; and

FIG. 7 is a block diagram illustrating greater detail of the lighting geometry processor of FIG. 5.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

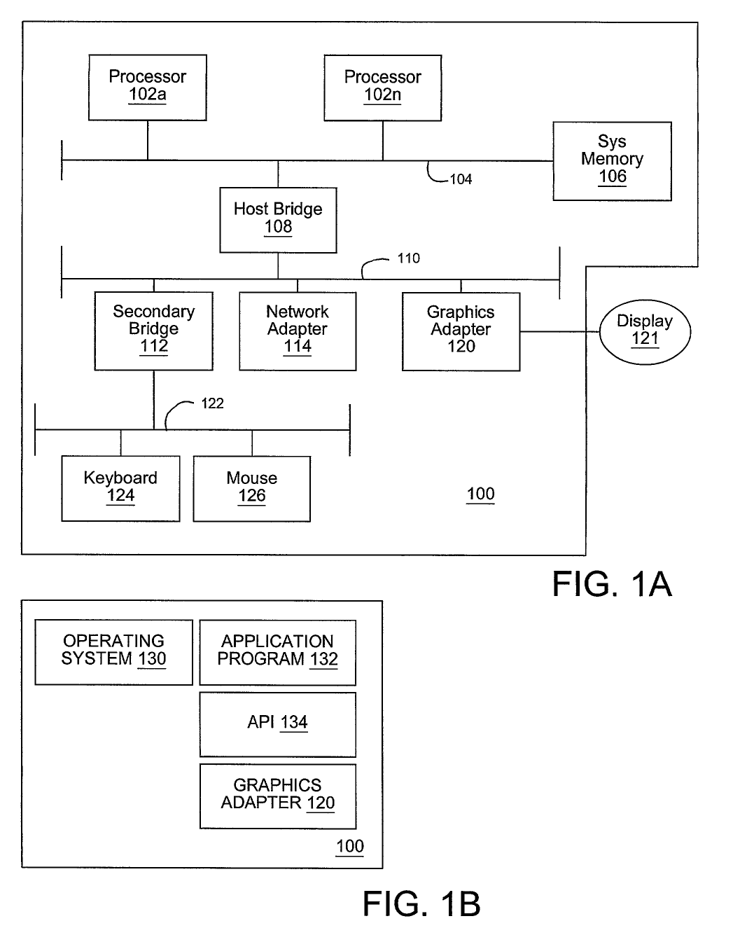

Turning now to the drawings, FIG. 1 is a block diagram of data processing system 100 according to one embodiment of the present invention. In the depicted embodiment, system 100 includes one or more processor(s) 102a through 102n (generically or collectively referred to herein as processor(s) 102) are connected to a system bus 104. Processors 102 may be implemented with any of a variety of microprocessor components including, as examples, PowerPC® processors from IBM Corporation, SPARC® processors from Sun Microsystems, and x86 compatible architectures such as the Pentium® family of processors from Intel Corporation and the Athlon® family of processors from Advanced Micro Devices, Inc.

A system memory (RAM) 106 is accessible to processors 102 via system bus 104. A host bridge 108 is connected between system bus 104 and an IO bus 110. IO bus 110 is typically implemented as a PCI bus (as specified in PCI Local Bus Specification Rev. 2.2 available from the PCI Special Interest Group at www.pcisig.com and incorporated by reference herein), or a PCI derivative such as the Advanced Graphics Protocol (AGP) bus defined by Intel Corporation. The depicted embodiment of system 100 includes various peripheral devices including a network adapter 114 suitable for connecting system 100 to computer network and a secondary bridge 120 that provides support for legacy IO devices such as a keyboard 124 and a mouse 126. System 100 further includes a graphics adapter 120 connected to IO bus 110. The graphics adapter 120 is enabled to process graphics data received via IO bus 110 and typically includes a video controller that controls the image displayed on a display device 121.

Referring now to FIG 1B, a conceptual illustration of the system software relevant to the present disclosure is depicted. During system operation, system memory 106 may include all or portions of an operating system 130. Suitable operating systems include the AIX® operating system from IBM Corporation (or another Unix derivative operating system), a Windows® family operating system from Microsoft, or a network operating system such as JavaOS® from Sun Microsystems. An application program 132 generates graphics scenes that are passed to an API 134. In an embodiment particularly relevant to the present disclosure, API 134 may be the OpenGL® API or the graPHIGS API that will be familiar to those in the field of 3D computer graphics. API 134 processes graphics scenes generated by application program 132 and, via graphics adapter 120, maintains the contents of a video display screen, plotter, or other suitable output device.

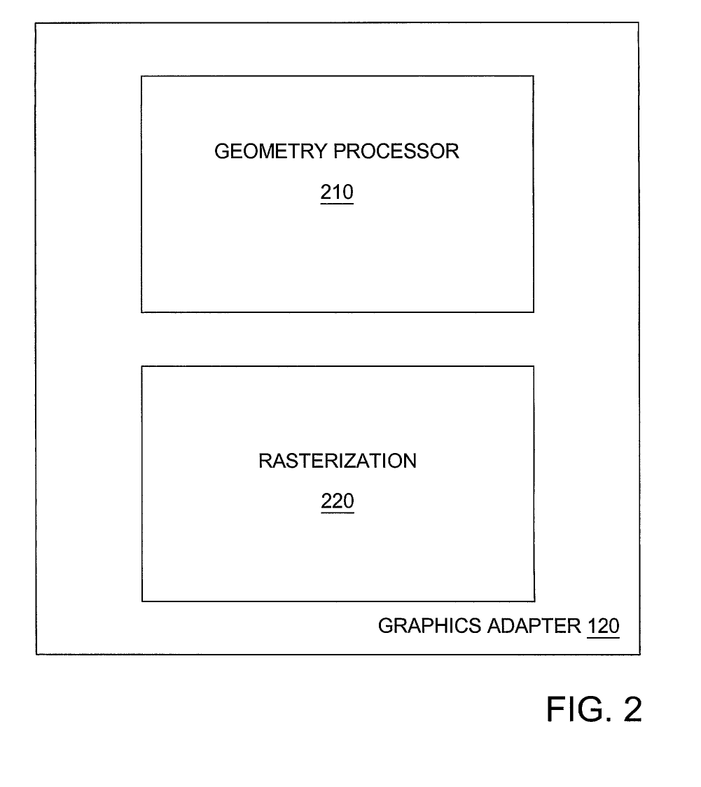

As depicted in FIG. 2, graphics adapter 120 includes a geometry processor 210 and a rasterization portion (rasterizer) 220. The geometry processor 210 performs complex calculations in response to data received from API 134 to generate the attributes specified by API 134. Rasterizer 220 determines pixel values for the display device based upon information received from geometry processor 210 and maintains the contents of a frame buffer 230 or other suitable graphics storage facility. Frame buffer 230 stores a representation of an image that is displayed on the screen of a display device. Frame buffer 230 is typically integrated into graphics adapter 120, but may comprise a separate unit.

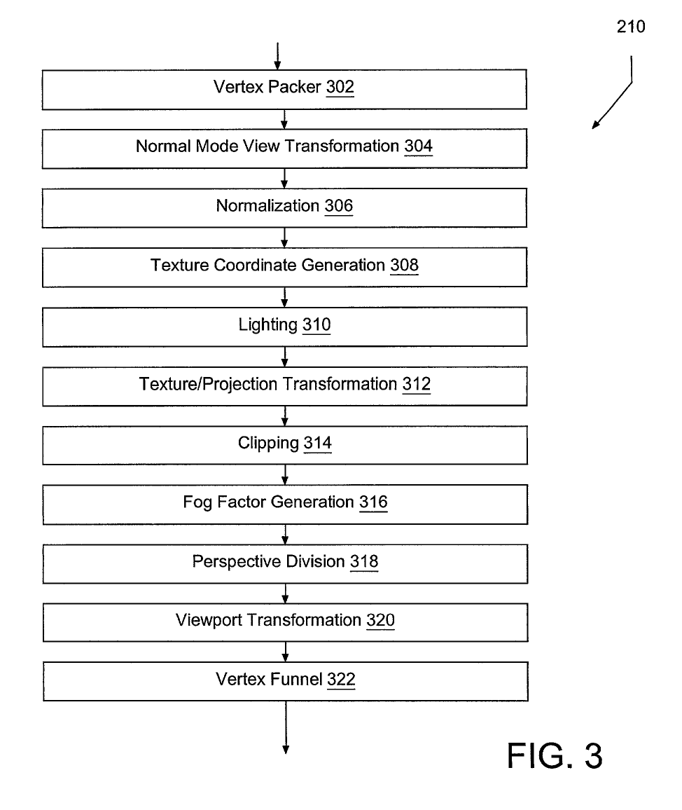

Referring now to FIG. 3, a simplified block diagram of one embodiment of a geometry processor (also referred to as geometry pipeline) 210 is presented. In the depicted embodiment, geometry pipeline 210 may receive data generated by API 134. In one embodiment, geometry processor 210 operates on 64-bit segments of data. Initially, object coordinates are received from API 134 by vertex packer 302, which is responsible for gathering the vertex fragments and storing them in the appropriate field. After the fragments have been stored, the vertex packer sends the entire vertex down geometry pipeline 300.

Vertex packer 302 forwards object coordinates to normal/model view transformation stage 304 where the normal vector is transformed from object space into eye space and the object coordinates are transformed into eye coordinates by translating, scaling, and rotating objects. The normalization stage 306 changes a normal vector to a vector of unit length (i.e., a vector having a magnitude of 1.0), while preserving the direction of the original vector. The texture coordinate generation block 306, as its name implies, is responsible for generating object linear, eye linear, or spherical texture coordinates.

The lighting stage 310 generates the color of each vertex of an object based on the orientation of the object and its material properties as well as the properties of the scene and any light sources that are defined. Texture/projection transformation stage 312 transforms texture coordinates by translating, scaling, and rotating objects and moves objects into a viewing volume by transforming eye coordinates into clip coordinates by translating, rotating, and scaling objects. Perspective projection makes objects that are further away from the viewer appear smaller whereas orthogonal projection does not.

Clipping stage 314 clips objects to a defined viewing volume while fog factor generation stage 316 makes objects fade into the distance by making objects further from the viewer less visible than objects closer to the viewer. The perspective division stage 318 transforms clip coordinates to normalized device coordinates [−1, +1] by dividing by the 4th coordinate (the W coordinate). The view transformation stage 320 facilitates the rasterization process by transforming normalized device coordinates into screen or window coordinates. Finally, the vertex funnel 322 sends the relevant fragments of the vertex to the raster interface sequentially.

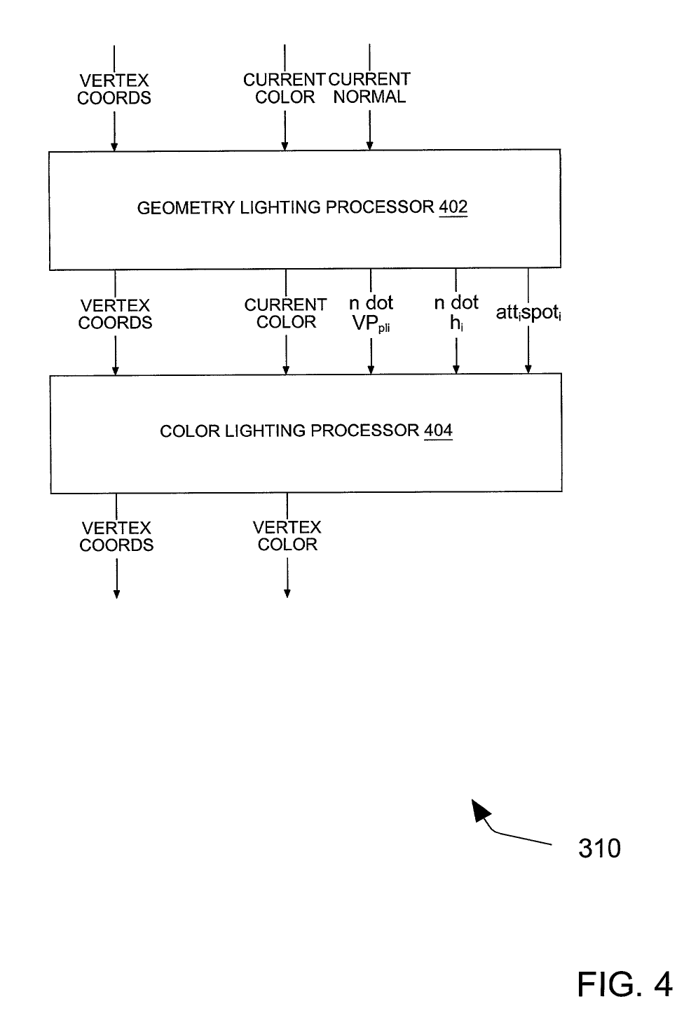

Turning now to FIGS. 4 through 6, additional detail of one embodiment of lighting stage 310 in accordance with the present invention is depicted. Generally speaking, lighting stage 310 is configured to generate primary and secondary colors for each vertex. In an API such as the OpenGL® API, each primary and secondary color consists of four floating point values, one for the red (R), green (G), blue (B), and alpha (A) components in that order. The color components are derived by performing API defined calculations using data associated with each vertex and scene. The vertex/scene data may include vertex spatial coordinates, coordinates of one or more light sources, the current normal vector, and parameters defining the characteristics of the light sources and a current material.

In the OpenGL® specification, if the Boolean parameter ces is TRUE, a primary color Cₚᵢ and a secondary color C_{sec} are computed for each vertex according to the following equations:

$$\begin{matrix}{C}_{pri} = {e}_{c m} + {a}_{c m} * {a}_{c s} + {\sum }_{( i = 0 , M - 1 )} \{ ( a t {t}_{i} ) ( {spot}_{i} ) [ {a}_{c m} * {a}_{c l i} + ( n {\cdot }^{⋀} V {P}_{pli} ) {d}_{c m} * {d}_{c l i} ] \} & Eq . 1 \\ {C}_{s e c} = {\sum }_{( i = 0 , M - 1 )} \{ ( a t {t}_{i} ) ( {spot}_{i} ) ( {f}_{i} ) {( n {\cdot }^{⋀} {h}_{i} )}^{s r m} {s}_{c m} * {s}_{c l i} \} & Eq . 2\end{matrix}$$

where e_{cm} is the emissive color of the current material, a_{cm} is the ambient color of the material, a_{cs} is the ambient color of the scene, a_{cli} is the ambient intensity of light source i (where there are M light sources), n is the normal vector of the current vertex, ˆ VPₚₗᵢ is the unit vector from the vertex (V) to the position (Pₚₗᵢ) of light source i, d_{cm} is the diffuse color of the material, d_{cli} is the diffuse intensity of light source i, sᵣₘ is the specular exponent, s_{cm} is the specular color of the material, s_{cli} is the specular intensity of light source i, fᵢ=1 if (n·VPₚₗᵢ)≠0 and fᵢ=0 otherwise, and hᵢ=ˆ VPₚₗᵢ+ˆ VPₑ if a Boolean variable v_{bs} is TRUE and hᵢ=ˆ VPₚₗᵢ+(0, 0, 1)^{T} if V_{bs} is FALSE where ˆ VPₑ is the unit vector from the vertex to the eye position. In addition:

$$the set of attenuation factors {att}_{i} = {\{ {k0}_{i} + {k1}_{i} \vert \vert {VP}_{pli} \vert \vert + {k2}_{i} \vert \vert {VP}_{pli} {\vert \vert}^{2} \}}^{- 1} \qquad Eq . 3$$

and

$$\begin{matrix}\begin{matrix}the set of spotlight \\ factors {spot}_{i}\end{matrix} = {{(}^{⋀} {P}_{pli} V \cdot {s}_{dli} )}^{⋀} {s}_{rli} , i f {c}_{rli} \neq 180 ° and \\ {}^{⋀} {P}_{pli} V \cdot {s}_{dli} >= cos ( {c}_{rli} ) \\ = 0 , if {c}_{rli} \neq 180 ° and \\ {}^{⋀} {P}_{pli} V \cdot {s}_{dli} < cos ( {c}_{rli} ) \\ = 1 , if {c}_{rli} = 180 ° .\end{matrix} \qquad Eq . 4$$

where k0ᵢ is the constant attenuation factor for light source i, k1ᵢ is the linear attenuation factor for light i, k2ᵢ is the quadratic attenuation factor for light source i, s_{dli} is the unit vector in the direction of the spotlight for light source i, sᵣₗᵢ is the spotlight exponent for light source i, and cᵣₗᵢ is spotlight cutoff angle for light source i.

Turning now to FIG. 4, lighting stage 310 may include a lighting geometry processor (LGP) 402 and a lighting color processor (LCP) 404. LGP 402 performs the bulk of the calculations required by the API specification. In the depicted embodiment, LGP 402 receives vertex coordinates and other data associated with a graphic primitive and computes the complex terms of Equations 1 and 2 above. More specifically, the depicted embodiment of LGP 402 receives vertex coordinates, texture coordinates, current color data, and current normal data and computes a first set of values (n·ˆ VPₚₗᵢ), a second set of values (n·hᵢ), and a third set of values (attᵢ)(spotᵢ) for each light source i.

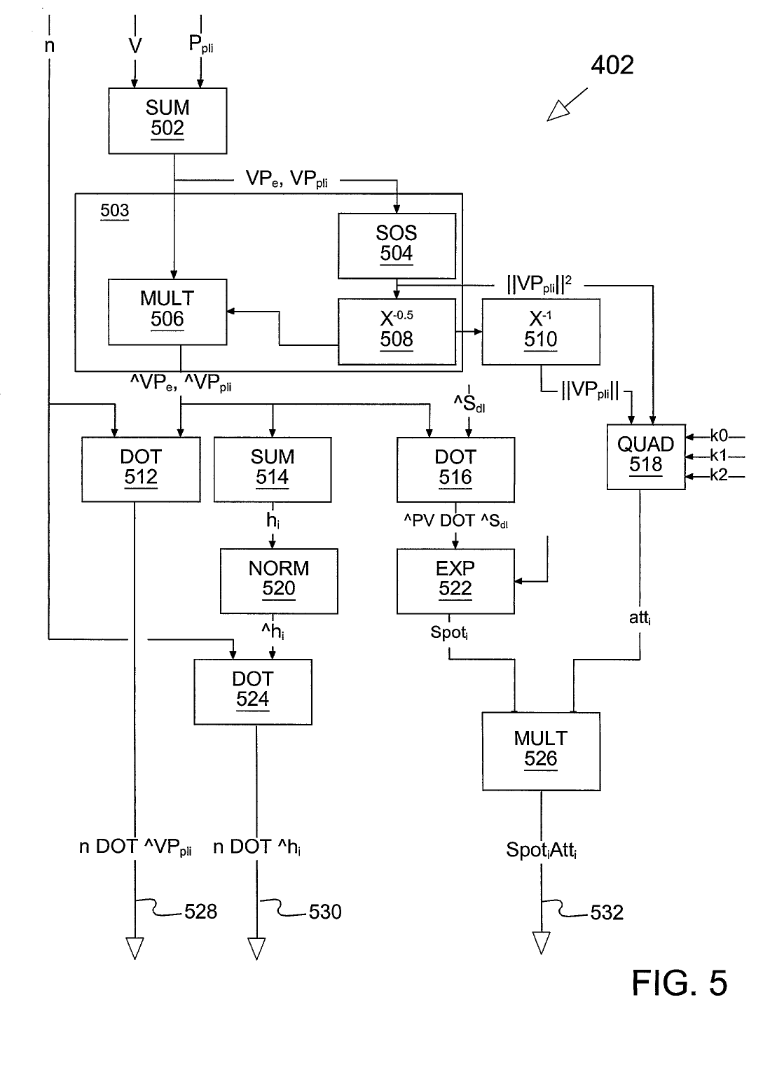

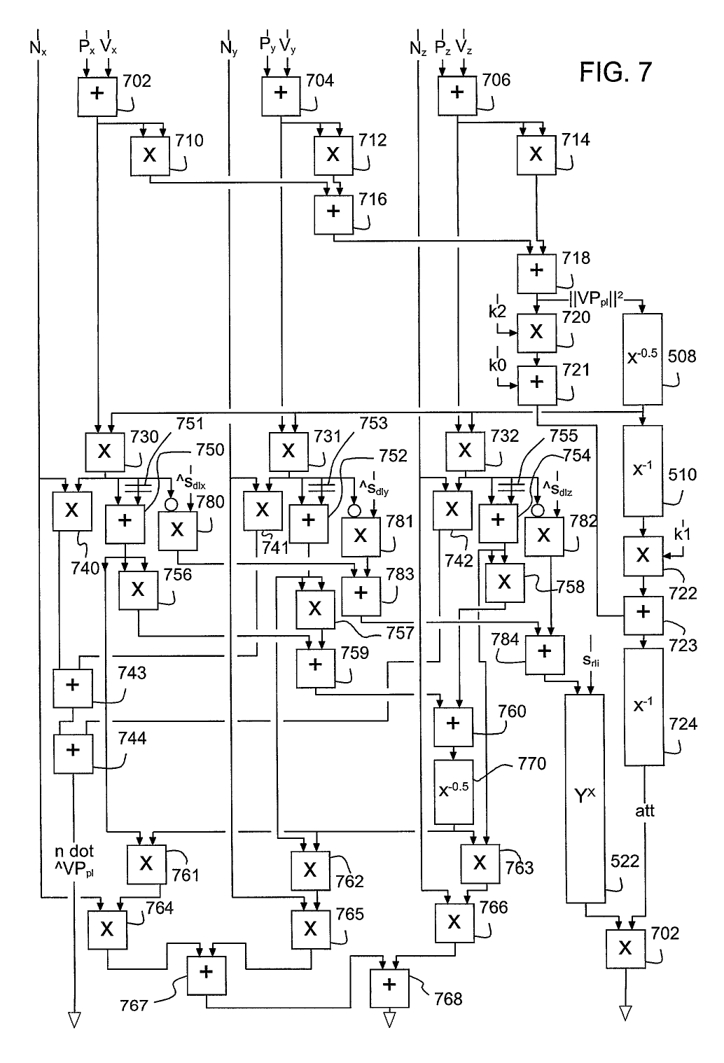

Referring now to FIG. 5 and FIG. 7, FIG. 5 is a functional block diagram of one embodiment of LGP 402 while FIG. 7 illustrates an exemplary implementation of the LGP 402 of FIG. 5. Generally speaking, LGP 402 includes a set of functional circuits configured to compute the complex terms needed to solve Equations 1 and 2. Reviewing Equations 1 through 4, the terms requiring significant computation include the n·ˆ VPₚₗᵢ, n·hᵢ, and (attᵢ)(spotᵢ) terms. Each of these terms must be computed for each enabled light source. If, for example, 16 light sources are enabled (and supported by the API), LGP 402 calculates 16 values for n·ˆ VPₚₗᵢ, 16 values for n·hᵢ, and 16 values for (attᵢ)(spotᵢ (where i indicates the i-th light source).

To manage the cost and complexity of LGP 402 without substantially sacrificing performance, LGP 402 is preferably implemented with appropriate latching circuitry at the inputs to each of the functional circuits. The latching circuitry enables the inputs to each functional circuit to change at appropriate transitions of a clock signal thereby facilitating re-use of each functional circuit. An adder circuit, for example, may add the x-component of the current vertex (Vₓ) to the x-component of the position of light source 0 (Pₚₗ₀ₓ) in a first clock cycle. The same adder circuit may then add Vₓ to the x-component of the position of light source 1 (Pₚₗ₁ₓ) in a second clock cycle, and so forth. In this manner, the total number of functional units used in LGP 402 is maintained. In addition to reducing the number of functional circuits required, latching circuitry used in LGP 402 provides a timing function that ensures that signals arrive at the inputs to the functional units at the correct time.

As depicted in FIG. 5, LGP 402 receives vertex data (V) that includes the x, y, and z coordinates of the vertex and normal data (n) that includes the x, y, and z coordinates of the normal vector corresponding to the vertex V. To simplify FIG. 5, the x, y, and z components of V and n are not separately illustrated. In addition, LGP 402 uses light position data Pₚₗ that includes x, y, and z coordinates of each enabled light source i and eye point data Pₑ that is typically retrieved from programmable registers (not depicted). In the OpenGL® specification, the eye point is a Boolean or single bit value that indicates whether the eye point is at the origin or at infinity. The eye point Pₑ is used to calculate the components of eye point vectors VPₑ. Each eye point vector VPₑ represents the vector from the corresponding vertex to the eye point.

LGP 402 includes summation circuitry 502 that computes the x, y, and z components for the set of light source vectors VPₚₗᵢ (the vectors from the vertex V to each of the i enabled light sources). In the embodiment depicted in FIG. 7, summation circuitry 502 of FIG. 5 is implemented with three floating point adders 702, 704, and 706. Typically, adder 702 computes the x-components of each VPₚₗᵢ in consecutive clock cycles while adder 704 computes the y-components, and adder 706 computes the z-components.

LGP 402 includes circuitry for determining a unit vector (normalized vector) from an “un-normalized” vector. This normalizing circuitry, indicated by reference numeral 503, is used to compute an eye point unit vector ˆ VPₑ from the eye point vector VPₑ and a set of i light source unit vectors ˆ VPₚₗᵢ from the set of light source vectors VPₚₗᵢ. In the embodiment depicted in FIG. 5, the normalizing circuitry includes a sum-of-squares (SOS) circuit 504 configured to receive VPₑ and each VPₚₗᵢ. SOS 504 computes a value equal to the sum of the squares of the x, y, and z components of the received vectors. SOS 504 may include a set of floating point multipliers 710, 712, and 714 that compute x², y², and z² values respectively from the x, y, and z vector components generated by adders 702, 704, and 706. Multipliers 710, 712, and 714 compute a square value by multiplying an input value by itself. Thus, the vector x-component sum produced by adder 702 provides both input values to multiplier 710 and similarly for the y-components and z-components. SOS 504 may further include a pair of adders 716 and 718 that, together, add the x², y², and z² values generated by multipliers 710, 712, and 714 to produce the sum-of-squares value x²+y²+z². It should be noted that the value output from SOS 504 of FIG. 5 (and adder 718 of FIG. 7) equals the square of the magnitude of the vector received by SOS 504. Thus, when SOS circuit 504 is generating a sum-of-squares value for VPₚₗ₀, for example, the output of SOS 504 equals ∥VPₚₗ₀∥².

The sum-of-squares values produced by SOS 504 provide input values to an inverse square root (ISR) circuit 508 that generates the value X^{-0.5} in response to receiving a value X. The output of ISR 508 represents the common denominator needed to compute the x, y, and z components of a unit vector (a vector that is normalized by multiplying each component of the unit vector by the inverse of the vector's magnitude). The denominator generated by ISR 508 is then multiplied in multiplication circuit 506 by the x, y, and z components of the input vector (i.e., the vector received by normalizing circuitry 503 ) to produce the components of the corresponding unit vector. As implemented in the embodiment depicted in FIG. 7, multiplication circuit 506 may include a three floating point multipliers 730, 731, and 732 for computing a unit vector's x-component, y-component, and z-component respectively. In one embodiment normalizing circuit 503 outputs, in consecutive cycles, the eye point unit vector ˆ VPₑ and the set of light source unit vectors ˆ VPₚₗᵢ.

The output of SOS circuit 504, which represents the square of the magnitude (∥VPₚₗᵢ∥²) of the corresponding light source vector VPₚₗᵢ, is also used in LGP 402 in conjunction with the quadratic attenuation factor k2ᵢ (see Equation 3 above). In the depicted embodiment, the output of SOS 504 provides an input to a quadratic circuit 518 that generates a value for attᵢ. The linear component of attᵢ requires the light source vector's magnitude (∥VPₚₗᵢ∥), which is generated by providing the output of ISR circuit 508 (which equals ∥VPₚₗᵢ∥⁻¹) to a floating point inverter circuit 510. The output of inverter 510 is then provided to quadratic circuit 518. In addition to receiving the values ∥VPₚₗᵢ∥ and ∥VPₚₗᵢ∥², quadratic circuit 518 is configured to receive a quadratic attenuation factor k2i, a linear attenuation factor k1i, and a constant attenuation factor k0i. As implemented in the embodiment depicted in FIG. 7, quadratic circuit 518 may include a multiplier 720 configured to multiply the magnitude squared value ∥VPₚₗᵢ∥² by the quadratic attenuation factor k2i and an adder 721 that adds the output of multiplier 720 to the constant attenuation factor k0i. A multiplier 722 of quadratic circuit 518 multiplies the magnitude ∥VPₚₗᵢ∥ by the linear attenuation factor k1i. The output of multiplier 722 and adder 721 are then added in adder 723 of quadratic circuit 518 to produce a value that equals the inverse of attᵢ. This result is then inverted in floating point inverter 724 to generate the value attᵢ.

The unit vectors ˆ VPₚₗᵢ generated by multiplier 506 are routed to a dot product circuit 512. Dot product circuit also receives the current normal vector n as an input and generates one of the three sets of values produced by LGP 402, namely, the n·ˆ VPₚₗᵢ values. In the embodiment depicted in FIG. 7, dot product circuit 512 includes three multipliers 740, 741, and 742 configured to receive, respectively, the x, y, and z components of the normal vector n and the light source unit vector ˆ VPₚₗᵢ. The output of multipliers 740 and 741 are then added together in floating point adder circuit 743 and the output of adder 743 is added to the output of multiplier 744 to produce the dot product value n·ˆ VPₚₗᵢ, which is output from LGP 402.

The eye point unit vector ˆ VPₑ and the set of light source unit vectors ˆ VPₚₗᵢ output from multiplier 506 are used to generate the n·ˆ hᵢ values that LGP 402 is responsible for producing. Initially, eye point unit vector ˆ VPₑ is added to a light source unit vector ˆ VPₚₗᵢ in sum circuit 514 to calculate a corresponding hᵢ vector. The hᵢ vector is then normalized in normalization circuit 520 to generate the unit hᵢ vector ˆ hᵢ. Finally, the ˆ hᵢ vector is then added in dot product circuit 524 to produce the value n·ˆ hᵢ. Referring to FIG. 7, sum circuit 514 may include a set of adders 751, 753, and 755 each with a first input configured to receive the output of multipliers 730, 731, and 732 respectively. A second input of adders 751, 753, and 755 is also connected to the output of multipliers 730, 731, and 732 respectively. Delay circuits 752, 754, and 756, are included between the output of multipliers 730, 731, and 732, and the second input of adders 751, 753, and 755. The delay circuit enables a first output of multipliers 730, 731, and 732 to be added to a second output of multipliers 730, 731, and 732. In the depicted embodiment, the delay circuit 752, 754, and 756 each includes a set of serially connected latches that delay the output of multipliers 730, 731, and 732 from reaching the second input of adders 751, 753, and 755 for a predetermined number of clock cycles. In one embodiment, multipliers 730, 731, and 732 produce the x, y, and z components of the eye point unit vector ˆ VPₑ in a first cycle. The components of eye point unit vector ˆ VPₑ are preferably latched into delay circuits 751, 753, and 755 respectively, such that they are available in subsequent cycles. In consecutive cycles following the first cycle, multipliers 730, 731, and 732 produce the x, y, and z components of VPpl0, VPpl1, VPpl2, and so forth. These light source unit vector components are then added to the eye point unit vector components using adders 750, 752, and 754 to produce the components for of hᵢ for each enabled light source.

The set of hᵢ vectors generated by sum circuit 514 are provided to a normalization circuit 520 to calculate a set of unit hᵢ vectors ˆ hᵢ. In the embodiment of FIG. 7, normalization circuit 520 includes multipliers 756, 757, and 758 that receive x, y, and z components of hᵢ from adders 750, 752, and 754 respectively. The values received from adders 750, 752, and 754 are multiplied by themselves to square each received value. These square value components are then added together using adders 759 and 760 to produce a sum-of-squares value at the output of adder 760 that represents the magnitude squared of the hᵢ vector ∥hᵢ∥². This magnitude squared value ∥hᵢ∥² is provided to a floating point ISR circuit 770 to generate a value equal to ∥hᵢ∥^{-0.5}, which is the denominator value needed to compute the components of the unit hᵢ vector ˆ hᵢ. The output of ISR circuit 770 is then provided to a trio of multipliers 761, 762, and 763 where it is multiplied by the x, y, and z components of hᵢ (output from adders 750, 752, and 754 respectively) to produce the x, y, and z components of the unit hᵢ vector ˆ hᵢ.

The n·ˆ hᵢ values are generated by calculating the dot product of the normal vector n and the hᵢ unit vector ˆ h₁ in dot product circuit 524. In the embodiment of FIG. 7, dot product circuit 524 may include a trio of multipliers 764, 765, and 766 that receive the x, y, and z components respectively of the normal vector n as well as the x, y, and z components respectively of the unit hᵢ vector ˆ hᵢ. The x, y, and z components of n and ˆ hᵢ are multiplied by each other with the trio of multipliers and provided to a pair of adders 767 and 768 that, together, add the values produced by multipliers 764, 765, and 766 to produce the dot product value n·ˆ hᵢ.

The third set of values produced by LGP 402 is the set of (attᵢ)(spotᵢ) values. In the embodiment depicted in FIG. 5, the set of light source unit vectors ˆ VPₚₗᵢ are provided to a dot product circuit 516 that also receives a unit vector ˆ s_{dli} where ˆ s_{dl1} defines the direction of a spotlight corresponding to light source i. The output of dot product circuit 516 is then raised to a power of srli in floating point exponentiation circuit 522, where srli is the exponent value corresponding to light source i (see Equation 4 above). The output of exponentiation circuit 522 represents the value spotᵢ, which is then multiplied in multiplication circuit 526 by the attᵢ output of quadratic circuit 518 to produce the value (attᵢ)(spotᵢ), which is output from LGP 402.

In the embodiment depicted in FIG. 7, dot product circuit 516 includes a trio of multipliers 780, 781, and 782 configured to multiply the x, y, and z components respectively of ˆ PₚₗᵢV by the corresponding components of the ˆ s_{dli} vector. The ˆ PₚₗᵢV components are generated by negating the corresponding components of ˆ VPₚₗᵢ output from multipliers 730, 731, and 732 respectively. This negation is represented by the inverted input in each of the multipliers 780, 781, and 782. The outputs of each of multipliers 780, 781, and 782 are then added together in adders 783 and 784 to generate the dot product value ˆ PₚₗᵢV·ˆ s_{dli}. This value is then raised to the power sᵣₗᵢ in exponentiation circuit 522 to generate a value for spotᵢ, which is then multiplied by attᵢ in multiplier 702 to produce a third result generated by LGP 402, namely, the (attᵢ)(spotᵢ) product. The three values generated by LGP 402 as described above are forwarded to the LCP 404 where the lighting stage can compute color values for each vertex received.

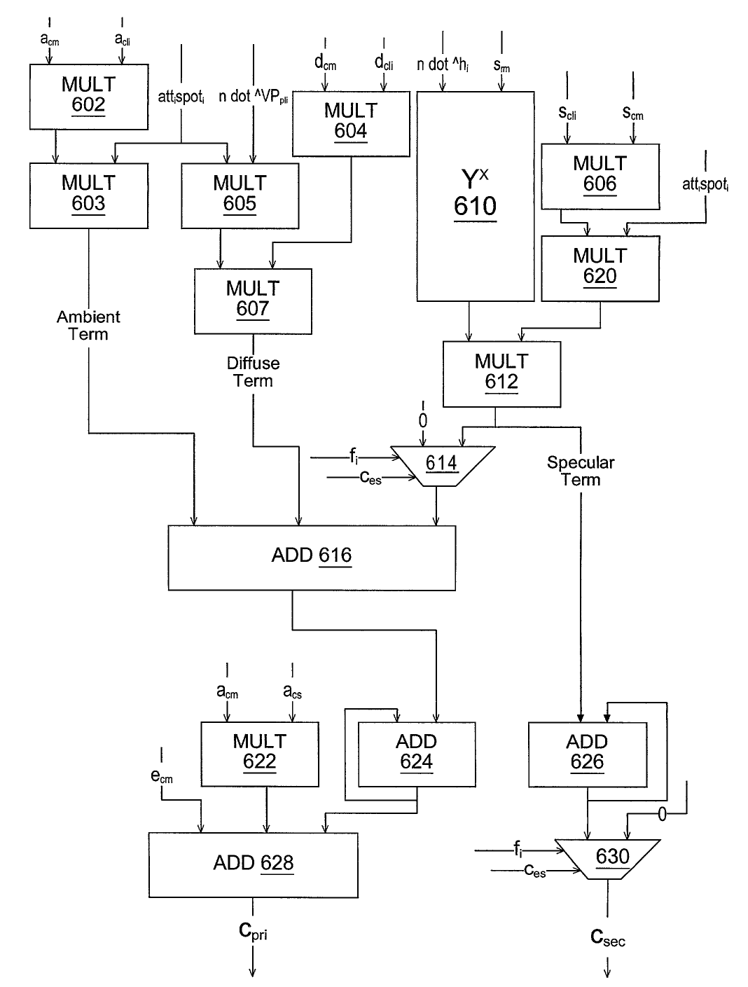

Turning now to FIG. 6, additional detail of an exemplary implementation of LCP 404 is depicted. In the depicted embodiment, LCP 404 is configured to receive the values generated by LGP 402. In addition, LCP 404 uses values for a set of parameters that define various attributes of the material, scene, and light source being processed. These values include the emissive color of the material (e_{cm}), the ambient color of the material (a_{cm}), the ambient color of the scene (a_{cs}), the ambient color of light source i (a_{cli}), the diffuse color of the material (d_{cm}), the diffuse color of light source i (d_{cli}), the specular color of the material (s_{cm}), the specular color of light source i (s_{cli}), and the specular exponent (sᵣₘ). One or more of these values may be stored in programmable registers of lighting stage 310.

Generally speaking, the depicted embodiment of LCP 404 calculates primary and secondary color values Cₚᵣᵢ and C_{sec} for each vertex. The color values may be calculated according to the OpenGL® equations identified above as Equation 1 and Equation 2. Typically, each primary and secondary color in OpenGL includes a red, green, blue, and alpha component. For the sake of clarity, FIG. 6 illustrates the circuitry used to generate a single component of the color values. LCP 404 typically includes four such circuits that operate in parallel to produce all four components of the color simultaneously. The calculation of color values under the OpenGL® specification requires a summation of factors computed for each lighting source that is used. In the preferred embodiment, the values for each lighting source are presented to LCP 404 in a pipelined manner. The latching required to implement this pipeline is eliminated from FIG. 6 to preserve clarity.

As depicted in FIG. 6, LCP 404 includes functional circuits that are configured to calculate each of the terms in Eq. 1 and Eq. 2, which are used to calculate Cₚᵣᵢ and C_{sec} if the Boolean parameter cₑₛ is true. If cₑₛ is FALSE, however, the primary color is calculated according to a modified version of Eq. 1 in which the (n·ˆ hᵢ)^{srm}s_{cm}*s_{cli} term is added to the a_{cm}*a_{cli} term and the (n·ˆ VPₚₗᵢ)d_{cm}*d_{cli} term. More specifically, if cₑₛ is FALSE, then:

Cₚᵣᵢ=e_{cm}+a_{cm}*a_{cs}+Σ_{(i=0, M-1)}{(attᵢ)(spotᵢ)[a_{cm}*a_{cli}+(n·ˆ VPₚₗᵢ)d_{cm}*d_{cli}+(fᵢ)(n·ˆ hᵢ)^{srm}s_{cm}*s_{cli}]} Eq. 5

C_{sec}=(0, 0, 0, 0) Eq. 6

Generally speaking, LCP 404 calculates the ambient term a_{cm}*a_{cli}(attᵢ)(spotᵢ), the diffuse term (n·ˆ VPₚₗᵢ)d_{cm}*d_{cli}(attᵢ)(spotᵢ), and the specular term (n·ˆ hᵢ)^{srm}s_{cm}*s_{cli}(attᵢ)(spotᵢ) of the OpenGL® color equations (Equations 1, 2, 5, and 6) in parallel. Multiplexer circuitry is used to steer the specular term to the primary color Cₚᵣᵢ or to the secondary color C_{sec} depending upon the value of cₑₛ. The summation function Σ is achieved using a pair of adders each configured with its output connected to one of its inputs.

More specifically as depicted in FIG. 6, LCP 404 includes a floating point multiplication circuit 602 that computes the product of the material ambient color a_{cm} and the ambient light intensity a_{cli} of each light source i, a multiplication circuit 604 that computes the product of the material diffuse color d_{cm} and the diffuse intensity d_{cli} of each light source i, and a multiplication circuit 606 that multiplies the material specular color s_{cm} by the specular intensity s_{cli} of each light source i. Each of the values used by circuits 602, 604, and 606 may be retrieved from one or more programmable registers. The output of multiplication circuit 602 is multiplied by (attᵢ)(spotᵢ) in multiplication circuit 603 to produce the ambient term. The diffuse term is calculated by multiplying, in multiplication circuit 607, the output of multiplication circuit 604 by the output of multiplication circuit 605. Multiplication circuit 605 computes the product of (attᵢ)(spotᵢ) and (n·ˆ VPₚₗᵢ) for each light source.

The specular term includes an exponential term that requires additional processing time to calculate. As depicted in FIG. 6, LCP 404 includes an exponentiation circuit 610 that computes the exponential term (n·ˆ hᵢ)^{srm}. Performance of LCP 404 is optimized by computing the remaining components of the specular term in parallel with the calculation of the exponential term. A multiplication circuit 606 generates the product of the material specular color s_{cm} and the specular intensity s_{cli} of each light source i. The output of circuit 606 is multiplied by (attᵢ)(spotᵢ) in a multiplication circuit 620. The outputs of exponentiation circuit 610 and multiplication circuit 620 are then multiplied together in multiplication circuit 612 to produce the specular term. The specular term is routed to the input of a multiplexer 614 that provides an input to an adder circuit 616. Multiplexer 614 receives cₑₛ and fᵢ as its select inputs. The 0 input to multiplexer 614 is provided to adder 616 If cₑₛ=TRUE or fᵢ=0, while the specular term output from multiplication circuit 612 is routed to adder 616 otherwise. Adder 616 computes the sum of the ambient term, the diffuse term, and the specular term (if cₑₛ is FALSE).

The specular term is also provided to adder circuit 626 for use in calculating C_{sec} when cₑₛ is TRUE. The output of adder 616 is connected to an adder 624 that performs the summation function Σ in Eq. 1 by connecting its output as its second input. After all lighting sources have been processed, the output of adder 624 will represent the value Σ_{(i=0, M-1)}{(attᵢ)(spotᵢ)[a_{cm}*a_{cli}+(n·ˆ Vpₚₗᵢ)d_{cm}*d_{cli}]} (for the case in which cₑₛ is TRUE). This value is then added in adder circuit 628 to the product of the material ambient color a_{cm} and the scene ambient color a_{cs} produced by multiplication circuit 622 and to the material emissive color e_{cm} to produce the primary color value Cₚᵣᵢ as an output value from LCP 404.

To generate the secondary color C_{sec} for the case in which cₑₛ is TRUE, the output of multiplication circuit 612 is connected to adder circuit 626, which performs the summation function Σ for the secondary color C_{sec} in the same manner as adder 624 for the primary color Cₚᵣᵢ. After all light sources are processed, the output of adder circuit 626 represents the value Σ_{(i=0, M-1)}{(attᵢ)(spotᵢ)(n·ˆ hᵢ)^{srm}s_{cm}*s_{cli}]}. This value is provided to a multiplexer 630. If cₑₛ is FALSE or fᵢ is 0, then the 0 input to multiplexer 630 is generated as the secondary color c_{sec}. Otherwise, the value output from adder circuit 626 represents the secondary color C_{sec}.

It will be apparent to those skilled in the art having the benefit of this disclosure that the present invention contemplates a hardware implemented lighting stage in the geometry pipeline of a graphics adapter. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A lighting circuit for use in a graphics adapter of a data processing system supporting a set of light sources, comprising:
a geometry stage configured to receive the coordinates of a graphic primitive vertex and the vertex's normal vector and further configured to:
calculate a first set of values, wherein each of the first set of values is indicative of the dot product of the normal vector and a unit vector from the vertex to a corresponding light source;
calculate a second set of values wherein each of the second set of values is indicative of the dot product of the normal vector and a unit half vector, wherein the unit half vector represents the vector sum of the unit vector from the vertex to the corresponding light source and the unit vector from the vertex to an eye point; and
calculate a third set of values wherein each of the third set of values is indicative of the product of an attenuation factor associated with each light source and a spotlight factor associated with each light source, wherein the attenuation factor decreases as the magnitude of the unit vector from the vertex to the corresponding light source increases; and
a color stage configured to receive at least the first, second, and third sets of values from the geometry stage and further configured to calculate at least a primary vertex color based thereon.

2. The circuit of claim 1, wherein each attenuation factor is indicative of the inverse of the sum of a constant attenuation factor, the product of a linear attenuation factor and the magnitude of the unit vector from the vertex to the light source, and the product of a quadratic attenuation factor and the square of the magnitude of the unit vector from the vertex to the light source.

3. The circuit of claim 2, wherein the spotlight factor is indicative of the dot product of a unit vector from the corresponding spotlight to the vertex and a unit vector in the direction of the corresponding light source.

4. The circuit of claim 1, wherein the color stage is further configured to generate the sum of a set of diffuse color products wherein each of the set of diffuse color products is associated with a corresponding light source, and wherein each of the set of diffuse color products equals the product of the appropriate first value, the corresponding third value, a diffuse material color, and the diffuse intensity of the corresponding light source.

5. The circuit of claim 4, wherein the color stage is further configured to generate the sum of a set of ambient color products, wherein each of the set of ambient color products is associated with a corresponding light source, and wherein each of the set of ambient color products equals the product of the appropriate third value, an ambient material color, and the ambient intensity of the corresponding light source.

6. The circuit of claim 5, wherein the color stage is further configured to generate the sum of a set of specular color products, wherein each of the set of specular color products is associated with a corresponding light source, and wherein each of the set of specular color products equals the product of the appropriate second value raised to a specified power, the appropriate third value, a specular material color, and a specular intensity of the corresponding light source.

7. The circuit of claim 6, wherein the color stage is further configured to sum the set of ambient color products, the set of diffuse color products together, the product of the material ambient color and a scene ambient color, and an emissive material color to produce the primary color for the vertex.

8. The circuit of claim 7, wherein the color stage is further configured to sum the set of specular color products to produce a secondary color for the vertex.

9. A graphics adapter suitable for use in a data processing system supporting a set of light sources, the graphics adapter including a lighting stage suitable for calculating at least a primary color, the lighting stage comprising:
a geometry stage configured to receive the coordinates of a graphic primitive vertex and the vertex's normal vector and further configured to:
calculate a first set of values, wherein each of the first set of values is indicative of the dot product of the normal vector and a unit vector from the vertex to a corresponding light source;
calculate a second set of values wherein each of the second set of values is indicative of the dot product of the normal vector and a unit half vector, wherein the unit half vector represents the vector sum of the unit vector from the vertex to the corresponding light source and the unit vector from the vertex to an eye point; and
calculate a third set of values wherein each of the third set of values is indicative of the product of an attenuation factor associated with each light source and a spotlight factor associated with each light source, wherein the attenuation factor decreases as the magnitude of the unit vector from the vertex to the corresponding light source increases; and
a color stage configured to receive at least the first, second, and third sets of values from the geometry stage and further configured to calculate at least a primary vertex color based thereon.

10. The graphics adapter of claim 9, wherein each attenuation factor is indicative of the inverse of the sum of a constant attenuation factor, the product of a linear attenuation factor and the magnitude of the unit vector from the vertex to the light source, and the product of a quadratic attenuation factor and the square of the magnitude of the unit vector from the vertex to the light source.

11. The graphics adapter of claim 10, wherein the spotlight factor is indicative of the dot product of a unit vector from the corresponding spotlight to the vertex and a unit vector in the direction of the corresponding light source.

12. The graphics adapter of claim 9, wherein the color stage is further configured to generate the sum of a set of diffuse color products wherein each of the set of diffuse color products is associated with a corresponding light source, and wherein each of the set of diffuse color products equals the product of the appropriate first value, the corresponding third value, a diffuse material color, and the diffuse intensity of the corresponding light source.

13. The graphics adapter of claim 12, wherein the color stage is further configured to generate the sum of a set of ambient color products, wherein each of the set of ambient color products is associated with a corresponding light source, and wherein each of the set of ambient color products equals the product of the appropriate third value, an ambient material color, and the ambient intensity of the corresponding light source.

14. The graphics adapter of claim 13, wherein the color stage is further configured to generate the sum of a set of specular color products, wherein each of the set of specular color products is associated with a corresponding light source, and wherein each of the set of specular color products equals the product of the appropriate second value raised to a specified power, the appropriate third value, a specular material color, and a specular intensity of the corresponding light source.

15. The graphics adapter of claim 14, wherein the color stage is further configured to sum the set of ambient color products, the set of diffuse color products together, the product of the material ambient color and a scene ambient color, and an emissive material color to produce the primary color for the vertex.

16. The graphics adapter of claim 14, wherein the color stage is further configured to sum the set of specular color products to produce a secondary color for the vertex.

17. A data processing system including processor, memory, input device, and display, the data processing system including graphics adapter including a lighting stage, the lighting stage comprising:
a geometry stage configured to receive the coordinates of a graphic primitive vertex and the vertex's normal vector and further configured to:
calculate a first set of values, wherein each of the first set of values is indicative of the dot product of the normal vector and a unit vector from the vertex to a corresponding light source;
calculate a second set of values wherein each of the second set of values is indicative of the dot product of the normal vector and a unit half vector, wherein the unit half vector represents the vector sum of the unit vector from the vertex to the corresponding light source and the unit vector from the vertex to an eye point; and
calculate a third set of values wherein each of the third set of values is indicative of the product of an attenuation factor associated with each light source and a spotlight factor associated with each light source, wherein the attenuation factor decreases as the magnitude of the unit vector from the vertex to the corresponding light source increases; and
a color stage configured to receive at least the first, second, and third sets of values from the geometry stage and further configured to calculate at least a primary vertex color based thereon.

18. The data processing system of claim 17, wherein each attenuation factor is indicative of the inverse of the sum of a constant attenuation factor, the product of a linear attenuation factor and the magnitude of the unit vector from the vertex to the light source, and the product of a quadratic attenuation factor and the square of the magnitude of the unit vector from the vertex to the light source.

19. The data processing system of claim 18, wherein the spotlight factor is indicative of the dot product of a unit vector from the corresponding spotlight to the vertex and a unit vector in the direction of the corresponding light source.

20. The data processing system of claim 17, wherein the color stage is further configured to generate the sum of a set of diffuse color products wherein each of the set of diffuse color products is associated with a corresponding light source, and wherein each of the set of diffuse color products equals the product of the appropriate first value, the corresponding third value, a diffuse material color, and the diffuse intensity of the corresponding light source.

21. The data processing system of claim 20, wherein the color stage is further configured to generate the sum of a set of ambient color products, wherein each of the set of ambient color products is associated with a corresponding light source, and wherein each of the set of ambient color products equals the product of the appropriate third value, an ambient material color, and the ambient intensity of the corresponding light source.

22. The data processing system of claim 21, wherein the color stage is further configured to generate the sum of a set of specular color products, wherein each of the set of specular color products is associated with a corresponding light source, and wherein each of the set of specular color products equals the product of the appropriate second value raised to a specified power, the appropriate third value, a specular material color, and a specular intensity of the corresponding light source.

23. The data processing system of claim 22, wherein the color stage is further configured to sum the set of ambient color products, the set of diffuse color products together, the product of the material ambient color and a scene ambient color, and an emissive material color to produce the primary color for the vertex.

24. The data processing system of claim 22, wherein the color stage is further configured to sum the set of specular color products to produce a secondary color for the vertex.
